(19) United States
(12) Patent Application Publication
(10) Pub. No.: US 2026/0326928 A1
(43) Pub. Date: Oct. 22, 2026

(54) NOVEL RE-ENTRY METHOD FOR REUSABLE ROCKETS AND SPACESHIPS RETURNING BACK TO EARTH FROM SPACE

(71) Applicant: K MANJUNATHA, Bangalore (IN)

(72) Inventors: K MANJUNATHA, Bangalore (IN); Arya MANJUNATHA, Bangalore (IN)

(21) Appl. No.: 19/139,738

(22) PCT Filed: Feb. 6, 2024
(86) PCT No.: PCT/IN2024/050114

§ 371 Date: Jun. 16, 2025

(30) Foreign Application Priority Data
Dec. 17, 2023 (IN) 202341086136

(51) Int. Cl. B64G 1/62; B64G 1/22; B64G 1/58

(52) U.S. Cl. CPC B64G 1/623; B64G 1/2222; B64G 1/58

(57) ABSTRACT

A spacecraft tail structure and a method of re-entry of a spacecraft/spaceship/rocket returning from space to earth is disclosed. The method includes decelerating the spacecraft while transitioning from a stable orbit to a ballistic re-entry trajectory towards a landing zone. Further, the method includes initiating an upward movement of the boom structure along with the petal structure having fins, with respect to the movement of the spacecraft. Further, the method includes extending the boom structure along with the petal structure and the fins from a resting position on the surface of the spacecraft to an extended position on the opposite side. Further, the method includes reorienting the petal structure and the fins through a half-circle rotation, while extension of the boom structure to a tail-level position.

### BACKGROUND OF THE INVENTION

Reusable rocketry demands repeated use of rocket hardware to significantly reduce the overall cost associated with launching and traveling to Space. The recovery of the first stage of a rocket presents fewer challenges in comparison to the recovery of the second or third stage. This is attributed to the fact that the first stage neither reaches orbital velocity nor attains higher altitude achieved by the second or third stage. The atmospheric re-entry phase of spacecraft or spaceship or second/ third stage of a rocket presents significant challenges, primarily due to the immense kinetic energy possessed by the stage. When returning from orbit, spacecraft or rockets can reach velocities exceeding 7 km/s. Blunt body spacecraft use a forward blunt body to dissipate this kinetic energy in the form of heat generated by friction (aero braking) with bombardment of oncoming air molecules and finally the spacecraft lands using a parachute. Winged spacecraft employ a large belly surface area with heat shield to reduce kinetic energy by frictional braking (drag, aero braking) and land on runways similar to a plane. However, re entry of reusable rockets present an unique challenge, as the blunt body approach is impractical due to the substantial kinetic energy associated with the higher mass of massive second or third stage. SpaceX company has addressed this problem by utilizing a NASA Space Shuttle type re-entry by exposing the belly of rocket stage (Starship) with thermal tiles to oncoming air for aero braking to reduce velocity. In the final moments of flight, the SpaceX Starship entire second stage is flipped by 90 degrees, transitioning from a horizontal to a vertical position with engines facing downward. These engines ignite and provide a last-leg of lifting force, enabling a soft landing option using giant clippers or deploy-able legs.

The disclosed invention here presents a novel method distinct from existing approaches for achieving re-entry from orbital/sub-orbital speeds and safely landing on Earth. This invention is not limited only to rocket stages but can be extended to spacecrafts—manned or cargo and returning from Space to Earth or Space to planets having atmosphere, like Mars or moons of Jupiter, Saturn,

### SUMMARY OF THE INVENTION

This invention is about new method for re-entry of spacecraft, rocket stages or spaceships from Space to Earth's atmosphere and uses retractable boom equipped with rotatable curved heat shield surfaces called petals (similar to flower petals). The curvature of these heat shield plates precisely match that of the rocket surface, whether conical or cylindrical - on which they rest during the ascent part of the flight. Integrated with an elevating system hinged at the top of the rocket stage (or appropriate location in the case of spaceships), this design enables the movement of the boom along with the complete petal structure including fins from its resting position to the other side of the hinge, offering a full 180 degree range of motion along with 180 degree rotation of the petals themselves on the axis of the boom, making fins stand out to oncoming air. In this configuration, the petals and fins form a dynamic structure that provides an elevated high-drag position, ensuring a stable and controlled atmospheric re entry for the host spacecraft/rocket stage/spaceship. The curved heat shield plates (petals), strategically positioned along the retractable boom, serve dual purpose. Firstly, they offer additional friction/drag area for effective aero braking, optimizing the dissipation of kinetic energy during re-entry. Secondly, these plates act as a stabilizing tail for the descending spacecraft, enhancing control and maneuverability during this critical phase of the re entry flight of the spacecraft/rocket-stage. This configuration provides natural stability for the spaceship/spacecraft/rocket-stage including spin stability, roll over stability and ability to fly or glide and directional control with minute adjustment (rotation) of fins.

### BRIEF DESCRIPTION OF THE DRAWINGS

FIG. 1 is diagram of a typical rocket showing various stages for representation purposes.

FIG. 2 is the diagram of second stage of a rocket with supporting structures for the implementation of invention including heat shield plates (petals), fins, movable boom.

FIG. 3 is the profile view from top of second stage showing petals, fins and boom attached to petals.

FIG. 4 is the profile view from side bottom of second stage showing petals, fins and boom and rocket engines.

FIG. 5 is the bottom view with engines visible along with expandable heat shield.

FIG. 6 shows the rotational axis of fins on petal structure.

FIG. 7 to FIG. 12 explain the steps involved in implementing disclosed invention.

### DETAILED DESCRIPTION OF THE INVENTION

Re-entry is the most difficult phase of a spacecraft or rocket stage entering back to earth. Rocket stage re-entry gets even more complicated as the mass of rocket stage attempting to re-enter earth's atmosphere is many times more compared to blunt body spacecrafts. With higher velocity (orbital or sub orbital) and higher mass (engines, propellant tanks, remaining propellants, landing structures etc), re-entry becomes extremely challenging. Scientists are still looking for various methods which can assist in atmospheric re-entry for large mass spacecrafts/rocket stages. Direction Control, Stability, Orientation, Roll/Spin Control and Ability to continue to fly at very low density thin atmosphere to dissipate kinetic energy are the main parameters to be managed for successful re entry into earth's atmosphere.

The invention disclosed here aims to help maintain natural stability, provide additional heat dissipation area (drag) for increased rate of resistance to oncoming air molecules (aero braking) and use control surfaces to fly or maintain flight, (continue to glide) and directional control stability, Spin control avoidance and forward roll control avoidance. All these are achieved using the invention disclosed here without disturbing the natural aerodynamic shape of the rocket, which is critical for ascent part of flight from Earth to Space. The invention also takes into account, packaging of supporting structures like fins and petals and retractable folding mechanism needed to achieve successful deployment of boom/tail, petals rotation and fin actuation.

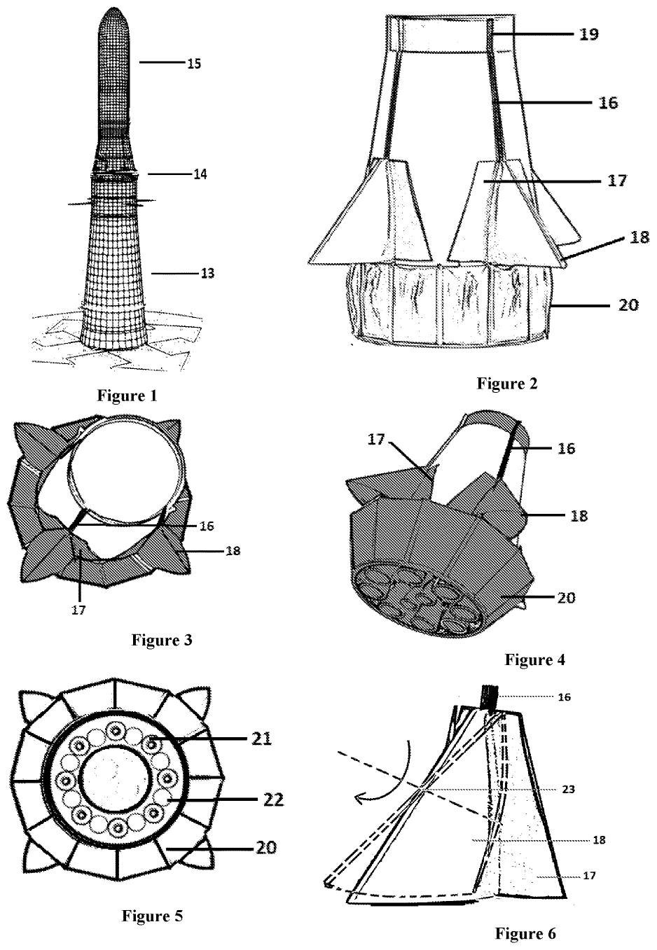

FIG. 1 shows the First stage (13) of a rocket with engines at the bottom, fuel-oxidizer tanks and stage separation mechanism above. On top of this rocket stage, a second stage, (14) or third stage (15) may be placed based on the requirements or design. This invention specifically talks about reusable second stage or third stage of a rocket or third stage modified as a spacecraft or spaceship with disclosed invention mechanisms installed, which has orbital or sub orbital speed and needs to shed enormous amount of kinetic energy in order to have a successful rocket stage recovery. Second stage, also known as sustainer stage by NASA, has a velocity greater than that of first stage but less than what is needed to reach and stay in orbit. On the other hand, third stage has enough velocity needed to stay in a stable orbit. Scope of the invention relates to re-entry, i.e, method/means of shedding kinetic energy at the earth's upper atmosphere and stability during flight using additional support mechanisms and structures including packaging on rocket-stage.

For any object re entering Earth from Space, the necessity to dissipate kinetic energy demands integration of an aero braking structures. This component interacts with oncoming air molecules, offering essential drag and resistance to facilitate controlled deceleration. FIG 2 shows second stage with additional mechanisms added to implement the invention disclosed here. 17 is the petal, which is heat shield structure with a curvature matching the shape of the stage on which it rests, be it conical or cylindrical. 18 are the fins which can rotate or turn. 16 is the boom structure which can rotate on the hing mechanism 19. This stage also carries retractable/expandable heat shield 20 which is not part of invention but shown as part of the rocket stage/spaceship/spacecraft. All mechanisms/parts 16, 17, 18,19 have thermal protection systems, ablative or thermal tiles or both.

FIG. 3 is the profile view from tilted top side of second stage showing petals, fins and boom attached to petals. The fins 18 are not just plates but bulged at the bottom.

FIG. 4 is the profile view from tilted bottom side of second stage showing petals, fins, boom and rocket engines which are placed at the bottom part of the stage. Retractable inflatable heat shield 20 (not part of the invention) is used to provide additional surface/friction/drag area to arrive at a favorable ballistic co-efficient needed for re entry of rocket stage into earth's atmosphere.

FIG. 5 provides a bottom view, showcasing the engine bells and the semi-deployed retractable inflatable heat shield 20. The engines are equipped with an engine bell heat shield cover mechanism (this mechanism is not a component of the invention). These covers protect the engines on re-entry flight during orbital or semi-orbital speeds and remain covered until the velocity decreases to approximately 2 km/s. At this point, the engines can safely be exposed to oncoming air, with room for velocity gain due to earth's gravity. Activation/ignition of the engines becomes an option if additional deceleration is required, contingent upon the residual mass of the rocket-stage/spacecraft/spaceship.

FIG. 6 shows the rotational axis of fins 18 on petal structure 17. During re entry, these fins can be slightly rotated forward or backwards on an axis 23 to provide directional control for the whole rocket stage. These fins and petals form tail structure for the whole spacecraft/rocket-stage/spaceship.

FIGS. 7 to 12 show the method of deployment of petals, fins and boom to form a dynamic tail at top of spacecraft.

### Re-Entry Method/ Mechanism

The re-entry process starts with the activation of engines to decelerate the spacecraft, departing from its stable orbit and transitioning into a ballistic re-entry trajectory towards Earth. In cases where the rocket stage is suborbital, engine support is still essential to re-orient towards direction of landing zone.

To maintain the correct orientation during re-entry, RCS thrusters are engaged, ensuring the entire rocket-stage/spacecraft/spaceship, with the engine section (with inflatable heat shield) align facing Earth. This re-entry maneuver is same for both second and third stages, accommodating various velocities, whether orbital or suborbital. In the vacuum of Space, as depicted in FIG. 7, the rocket-stage moves downwards due main engine burn (deceleration) and realignment by RCS thrusters, (arrow shows direction of motion). The subsequent figures illustrate the sequential steps of the re-entry process for the disclosed invention.

FIG. 8: The boom, accompanied by the entire petal structure initiates an upward movement.

FIG. 9: The upward motion of the boom continues, accompanied by the onset of petal rotation along the axis of the boom.

FIG. 10: Petals and boom progress further upwards, approaching the upper part (tail) of the stage and petal rotation continues.

FIG. 11: The boom reaches an almost tail-level position, and petals continue their rotation, completing almost half a circle.

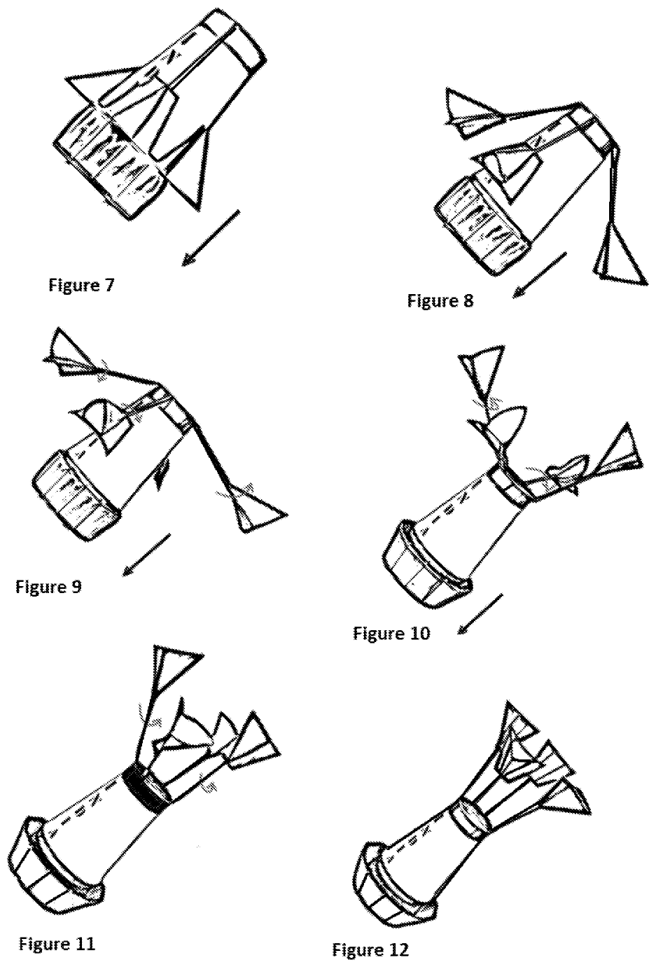

FIG. 12: The fully formed tail structure is showcased, with freely interlocking petals and outward-exposed fins. Following this sequence, the retractable and inflatable heat shield near the engine side is fully deployed (not part of the invention), culminating in the final configuration for the return flight of the rocket-stage/spacecraft/ spaceship.

### Functionality

As the rocket-stage encounters the bombardment of air molecules and ions in the upper atmosphere, the tail structure formed by the loosely joined petal structures, serves as a guiding mechanism, ensuring the rocket-stage maintains stable flight throughout the atmospheric descent. The tail structure formed at the rear of the spacecraft through method described above as shown in FIG. 7 to FIG. 12, serves multiple crucial functions. They include Mitigating Parasitic Spin, by effectively countering parasitic spin along the axis of motion, Preventing Forward Roll, ensuring stability by avoiding forward roll, particularly along an axis perpendicular to the direction of motion, Leveraging Natural Stability by capitalizing on the inherent stability provided by the tail structure and finally Enabling Flight Capability by facilitating the ability to fly, transforming the spacecraft/rocket-stage/ spaceship into a dynamic flying body.

During re entry, any flying body encountering bombardment of air molecules, spin due to uneven aerodynamic forces or misalignment of centre of mass and centre of pressure. Sometimes, spin may be started due to initial tumbling, unaddressed and left alone. The disclosed invention helps to avoid/control spin issues seen during re entry phase of the flight using dynamic tail structure.

### Mitigating Parasitic Spin along the Axis of Motion

Effective control of parasitic spin along the axis of motion is achieved through the adjustment of fins 18 on an axis 23 perpendicular to the petals, illustrated in Fig 6. The subtle tuning of the fin allows for a decrease or increase in the angle of attack against oncoming air molecules, providing precise control over parasitic spin, ensuring optimal stability.

### Preventing Forward Roll with Tail Section

The dynamic tail section plays a pivotal role in preventing forward roll, characterized by the entire rocket stage rotating along an axis perpendicular to its direction of motion. The tail petals 18 contribute a feathering effect, actively countering forward roll tendencies and thereby enhancing the overall stability of the rocket-stage.

### Natural Stability

Flying objects equipped with a tail inherently possess a natural stability, attributed to the counter balancing forces exerted on the tail section. These forces effectively nullify instantaneous changes in velocity or direction induced by the intricate aerodynamic interactions with oncoming air molecules. This invention focuses precisely on enhancing stability by introducing a tail section to a rocket-stage/spacecraft/spaceship during re-entry phase of the flight. As depicted in FIG. 12, the fully configured tail strategically face the oncoming air molecules through the downward motion of the rocket-stage, facilitating the attainment of inherent stability.

### Enhanced Flight Capabilities Utilizing Petals as Aerodynamic Structures for Keeping Engine Section—Nose Section High, Pointing Upwards

As illustrated in FIG. 12, the dynamic ability to fly is harnessed through the strategic utilization of petals as integral flying structures. The outward movement of any petal disrupts aerodynamic forces, particularly the lower petal inducing nose up position at the rocket engine section. The unique design, shown in FIG. 12, showcases petals that interlock freely, affording a considerable degree of freedom to extend outward. This configuration aids the rocket-stage in achieving flight within the thin upper atmosphere.

A critical aspect of achieving flight is maintaining a high nose position, where, in this context, the engine section at the bottom (depicted in FIG. 12) serves as the nose. The dynamic tail structure, formed by the interlocking petals and fins, contributes to stabilizing the flight, ensuring optimal orientation with the engine section as the leading point and the tail acting as the aerodynamically stabilized rear structure.

### Advantages of this Invention

Reduced RCS Thruster Fuel Consumption: Rocket stage/Spacecraft/ Spaceship with the mechanisms installed disclosed in the invention helps to maintain direction, stability and orientation passively and reduce dependence on active RCS thrusters for maintaining orientation and stability.
Natural Stability: The dynamic tail structure ensures inherent natural stability during re entry phase of the flight.
Minimal change in Aerodynamic Drag during ascent phase of rocket flight: Despite the introduction of additional mechanisms like petals, fins, and booms, the aerodynamic drag during the ascent phase of the rocket flight remains relatively similar due to clever packaging.
Parasitic Spin Avoidance: The design allows for effective control over parasitic spin along an axis aligned with the direction of motion.
Control over Forward Rolling Spin: The dynamic tail mechanism avoids forward rolling spin occurring along an axis perpendicular to the direction of motion.
Increased Drag for Rocket-Stage during re entry: The added mechanisms/structures increase drag area for rocket stage and contribute to controlled descent/re-entry.
Flight Capability: The design incorporates the ability to fly, utilizing petals as structure to provide forward lifting force for the engine section, maintaining nose up -stable orientation.

1-5 (canceled)

6. A method of re-entry for a spacecraft returning from space, the spacecraft comprising a petal structure having fins, the petal structure coupled to a boom structure is adapted to rotate on a hinge structure the spacecraft while returning from the space is characterized by:
decelerating the spacecraft by activation of engines while transitioning from a stable orbit to a ballistic re-entry trajectory towards a landing zone, the engines positioned beneath the petal structure surrounded by a retractable and expandable heat shield;
initiating an upward movement of the boom structure along with the petal structure, with respect to the movement of the spacecraft, wherein the fins of the petal structure rotates with respect to an axis normal to surface of the petal structure;
extending the boom structure along with the petal structure and the sins from a resting position on the surface of the spacecraft to an extended position on the opposite side;
reorienting the petal structure and the fins through a half-circle rotation, while extension of the boom structure to a tail-level position, wherein by the way of the rotation along the axis, the petal structure is adapted to align longitudinally with respect to the spacecraft with the fins facing inwards.

7. The method as claimed in claim 6, wherein the retractable and expandable heat shield is adapted to be deployed in an expanded form while the spacecraft is maneuvered by the orientation of the petal structure.

8. A spacecraft tail structure for returning the spacecraft from space, the spacecraft rail structure comprising:
a first stage, a second stage, and a third stage interconnected detachably with each other, each of the second and third (14, 15) comprises:
a petal structure defining a curvature placed longitudinally along the second stage, wherein the petal structure is coupled to a boom structure is adapted to rotate on a hinge structure, the petal structure includes fins adapted to rotate normal to surface of the petal structure,
wherein the petal structure along with the boom structure is adapted to move upwards extending the boom structure along with the petal structure and the fins from a resting position on the surface of the spacecraft to an extended position on the opposite side, wherein the fins of the petal structure rotates with respect to an axis normal to surface of the petal structure,
wherein the petal structure is adapted to be reoriented through a half-circle rotation, while extension of the boom structure to a tail-level position, wherein by way of the rotation along the axis, the petal structure is adapted to align longitudinally with respect to the spacecraft with the fins facing inwards.

9. The spacecraft tail structure as claimed in claim 8, wherein the curvature of the petal structure precisely match with surface of the spacecraft and the petal structure is adapted to rest during an ascent part of the spacecraft flight.

10. The spacecraft tail structure as claimed in claim 8, where in petal structure is a heat shield plate adapted to be extended during deceleration of the spacecraft while transitioning from a stable orbit to a ballistic re-entry trajectory towards a landing zone.

11. The spacecraft tail structure as claimed in claim 8, wherein the fins of the petal structure are capable of rotational movement along an axis perpendicular to the petal surface, wherein the fins are adapted to act as control surface at the back of the spacecraft by providing directional control during the re-entry of the spacecraft in upper atmosphere.
A spacecraft tail structure and a method of re-entry pf a spacecraft/spaceship/rocket returning from space to earth disclosed. The method includes deceleration the spacecraft while transitioning from a stable orbit to a ballistic re-entry trajectory towards a landing zone. Further, the method includes initiating an upward movement of the boom structure along with the petal structure having fins, with respect to the movement of the spacecraft. Further, the method includes extending the boom structure along with the petal structure and the fins from a resting position on the surface of the spacecraft to an extended position on the opposite side. Further, the method includes reorienting the petal structure and the fins through a half-circle rotation, while extension of the boom structure to a tail-level position.
